(19) United States
(12) Patent Application Publication
(10) Pub. No.: US 2026/0254587 A1
(43) Pub. Date: Aug. 27, 2026

(54) SRS CONFIGURATION AND TRANSMISSION IN MULTI-DCI MULTI-TRP AND CARRIER AGGREGATION

(71) Applicant: Intel Corporation, Santa Clara, CA (US)

(72) Inventors: Guotong WANG, Beijing (CN); Alexei DAVYDOV, Nizhny Novgorod (RU); Bishwarup MONDAL, San Ramon, CA (US)

(73) Assignee: Intel Corporation, Santa Clara, CA (US)

(21) Appl. No.: 19/445,358

(22) Filed: Jan. 9, 2026

Related U.S. Application Data
(63) Continuation of application No. 18/007,561, filed on Jul. 14, 2020, now abandoned.

(51) Int. Cl. H04L 5/00; H04B 7/06; H04W 72/1263; H04W 72/23

(52) U.S. Cl. CPC H04L 5/0051; H04B 7/06952; H04W 72/1263; H04W 72/23

(57) ABSTRACT

Systems, apparatuses, methods, and computer-readable media are provided to address SRS configuration and transmission in the scenario of multi-DCI multi-TRP operation. Other embodiments may be described and/or claimed.

### CROSS REFERENCE TO RELATED APPLICATIONS

This application is a continuation application of U.S. application Ser. No. 18/007,561, filed Dec. 1, 2022, now U.S. Publication No. 2023/0216639 A1, published Jul. 6, 2023, which this application is a national phase entry under 35 U.S.C. § 371 of International Application No. PCT/CN2020/101784, filed Jul. 14, 2020, entitled “SRS CONFIGURATION AND TRANSMISSION IN MULTI-DCI MULTI-TRP AND CARRIER AGGREGATION,” which designated, among the various States, the United States of America. The Specification of the PCT/CN2020/101784 application is hereby incorporated by reference in its entirety for all purposes, except for those sections, if any, that are inconsistent with this application.

### BACKGROUND

Various embodiments generally may relate to the field of wireless communications.

### BRIEF DESCRIPTION OF THE FIGURES

FIG. 1 illustrates the operation of single DCI and multi-DCI for multi-TRP in accordance with various embodiments.

FIG. 2 illustrates an example of RRC configuration for an SRS resource set in accordance with various embodiments.

FIG. 3 illustrates an example of RRC configuration for an SRS resource in accordance with various embodiments.

FIG. 4 illustrates an example of TRP-specific SRS triggering in accordance with various embodiments.

FIG. 5 illustrates an example of TRP-specific SRS triggering with different slot offsets in accordance with various embodiments.

FIG. 6 illustrates an example of multiple SRS resource sets with the same usage in multi-DCI, multi-TRP operation in accordance with various embodiments.

FIG. 7 illustrates an example of an independent postponed SRS transmission in multi-TRP operation in accordance with various embodiments.

FIG. 8 shows an example of the collision handling for SRS triggered by multiple TRPs. The SRS triggered by the TRP with the lowest TRP ID is transmitted in accordance with various embodiments.

FIG. 9 illustrates an example of multiple SRS resources sets with the same usage in carrier aggregation in accordance with various embodiments.

FIG. 10 illustrates an example of independent postponed SRS transmission among different CCs in accordance with various embodiments.

FIG. 11 illustrates an example of collision handling for SRS triggered by multiple CCs in accordance with various embodiments.

Figure YX illustrates a network in accordance with various embodiments.

Figure YY schematically illustrates a wireless network in accordance with various embodiments.

Figure YZ is a block diagram illustrating components, according to some example embodiments, able to read instructions from a machine-readable or computer-readable medium (e.g., a non-transitory machine-readable storage medium) and perform any one or more of the methodologies discussed herein.

Figure X-1 depicts an example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

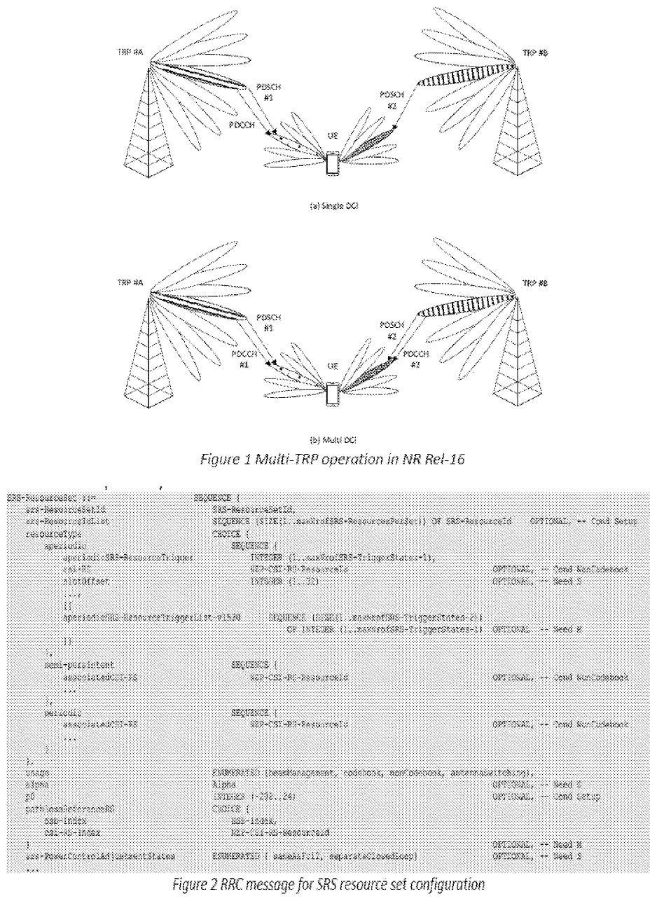

In 5G NR Rel-16, multi-transmission and reception point (multi-TRP) operation is introduced mainly for physical downlink shared channel (PDSCH) transmissions. Depending on different backhaul assumptions (ideal backhaul and non-ideal backhaul), the multi-TRP operation includes single DCI (Downlink Control Information) operation and multi-DCI operation. Multi-DCI corresponds to the non-ideal backhaul assumption. With multi-DCI, each TRP could have one PDCCH scheduling the corresponding PDSCH transmission. Single-DCI corresponds to the ideal backhaul assumption. With single-DCI, single PDCCH transmission could schedule PDSCH transmissions from multiple TRPs. FIG. 1 illustrates the operation of single DCI and multi-DCI for multi-TRP.

With multi-DCI multi-TRP operation, there could be multiple CORESET pools. One CORESET could be configured with a parameter CORESETPoolIndex, which can differentiate TRPs. For example, the value of 0 for CORESETPoolIndex corresponds to TRP #A, and the value of 1 corresponds to TRP #B.

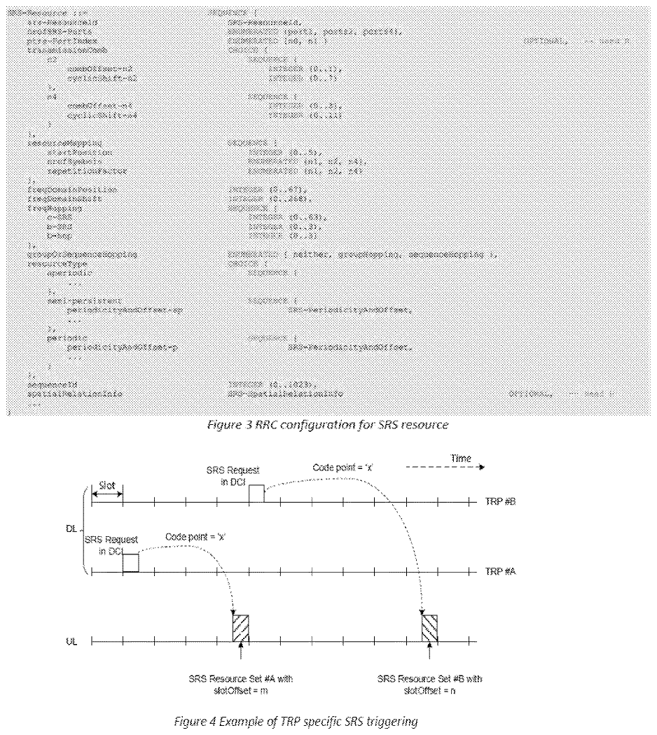

In the Rel-15 spec, different types of SRS resource sets are supported. The SRS resource set is configured with a parameter of ‘usage’, which can be set to ‘beamManagement’, ‘codebook’, ‘nonCodebook’ or ‘antennaSwitching’. The SRS resource set configured for ‘beamManagement’ is used for beam acquisition and uplink beam indication using SRS. The SRS resource set configured for ‘codebook’ and ‘nonCodebook’ is used to determine the UL precoding with explicit indication by TPMI (transmission precoding matrix index) or implicit indication by SRI (SRS resource index). Finally, the SRS resource set configured for ‘antennaSwitching’ is used to acquire DL channel state information (CSI) using SRS measurements in the UE by leveraging reciprocity of the channel in TDD systems. For SRS transmission, the time domain behavior could be periodic, semi-persistent or aperiodic. FIG. 2 and FIG. 3 shows the RRC configuration for SRS resource set and SRS resource respectively.

When SRS resource set is configured as ‘aperiodic’, the SRS resource set also includes configuration of slot offset (slotOffset) and trigger state(s) (aperiodicSRS-ResourceTrigger, aperiodicSRS-ResourceTriggerList). The parameter of slotOffset defines the slot offset relative to PDCCH where SRS transmission should be commenced. The triggering state(s) defines which DCI codepoint(s) triggers the corresponding SRS resource set transmission.

The slot offset is defined at SRS resource set level, e.g. the slot offset is common for all SRS resources in the SRS resource set. When aperiodic SRS is triggered, the UE should send aperiodic SRS after receiving DCI according to the slotOffset defined by RRC.

However, in the scenario of multi-DCI multi-TRP operation, there might be some issue with the SRS configuration and transmission. For example, there might be collision if both TRPs trigger the same SRS resource set/different SRS resource sets to be transmitted in the same slot. Therefore, some scheme is needed to reduce the collision, or some rules should be defined to handle the collision if it happens. The current SRS configuration and transmission doesn't consider multi-TRP operation, and embodiments of the present disclosure may (among other things) address SRS configuration and transmission in the scenario of multi-DCI multi-TRP operation.

### Scenario A: SRS Transmission in Multi-DCI Multi-TRP

### SRS Triggering and Configuration

In an embodiment, for SRS triggering in multi-DCI multi-TRP, the SRS trigger state indicated by the code point of SRS Request field in DCI could be TRP specific. The same code point of SRS Request field could trigger different SRS resource set by different TRPs. FIG. 4 shows an example of the operation.

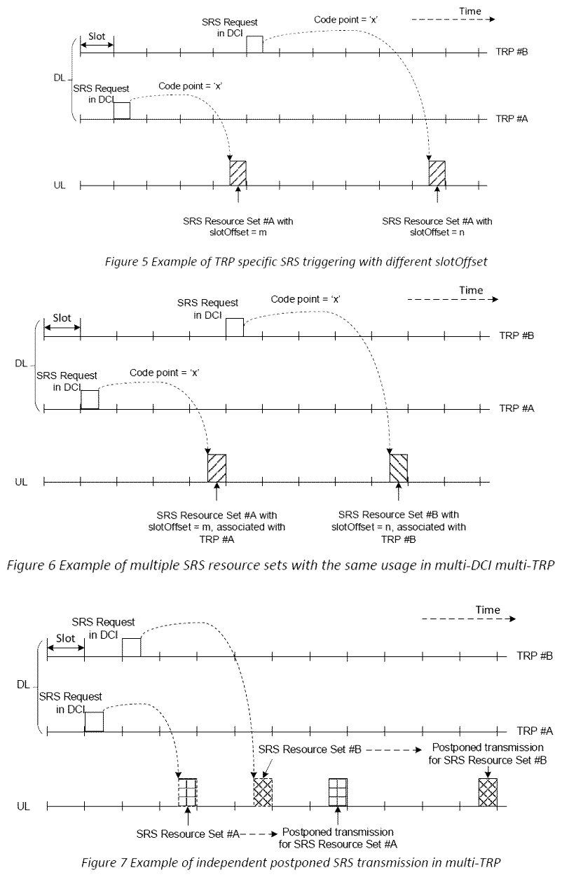

In another embodiment, for SRS triggering in multi-DCI multi-TRP, the same code point of SRS Request field in DCI from different TRPs could trigger the same SRS resource set but with different slot offset. FIG. 5 shows an example of the operation.

In another embodiment, for multi-DCI multi-TRP, multiple SRS resource sets could be configured for the same usage (codebook based transmission, non-codebook based transmission, antenna switching and beam management). The multiple SRS resource sets with the same usage could be configured with the same/different trigger state, and the same/different slotOffset.

The SRS could be associated with different TRPs, e.g. different CORESETPoolIndex. The association between SRS and TRP could be defined at SRS resource set level/SRS resource level or in the SRS spatial relation info, by a new RRC parameter, for example, associatedCORESETPool-SRS. The SRS resource sets with the same usage setting should be associated with different TRPs. For example, in the multi-TRP operation with two TRPs, two SRS resource sets could be defined for codebook based transmission, and each SRS resource set is associate with one TRP. When sending SRS Request in the DCI from one TRP, only the SRS resource set associated with the TRP will be triggered. FIG. 6 shows an example of the operation.

For codebook based transmission, when scheduling PUSCH transmission, the SRI field indicates one SRS resource in the SRS resource set associated with the scheduling TRP. Alternatively, a new field could be introduced in DCI to indicate the SRS resource set.

For non-codebook based transmission, with multiple SRS resource sets, different CSI-RS resource sending by different TRP could be associated with different SRS resource set. The UE can calculate different precoders for SRS transmission toward different TRPs based on the measurement on CSI-RS. When scheduling PUSCH transmission, the SRI field indicates one or more SRS resources in the SRS resource set associated with the scheduling TRP. Alternatively, a new field could be introduced in DCI to indicate the SRS resource set.

### Postponed SRS Transmission and Overlapping Handling

In an embodiment, in multi-DCI multi-TRP, the postponed SRS transmission could be applied, e.g. if there is no available uplink resource/slot for the SRS transmission, then the triggered SRS should be postponed until the next available uplink slot. The postponed SRS transmission should be performed independently among TRPs. There should be some coordination among TRPs. FIG. 7 shows an example of the operation. In the example, TRP #A triggers SRS resource set #A with slot offset of 2 in slot #N, and the SRS resource set #A transmission is postponed to slot #N+6. Between Slot #N and slot #N+6, TRP #B trigger another SRS resource set, SRS resource set #B. In this case, SRS resource set #B will not be transmitted in slot #N+6 and it will be further postponed to next available uplink slot, slot #N+10. In another example, assuming the available uplink slot for SRS transmission is slot M, a window could be defined for the postponed transmission, for example, X slots. During the period from slot M-X to slot M, if the first triggered SRS is from TRP #A, then slot M should be used to transmit the SRS triggered by TRP #A. The SRS triggered by another TRP, TRP #B, during the period from slot M-X to slot M will be further postponed after slot M. Furthermore, if multiple SRS are triggered by TRP #A during slot M-X to slot M, then the most recent SRS triggered by TRP #A during slot M-X to slot M should be transmitted in slot M.

In another embodiment, in multi-DCI multi-TRP, collision may happen for the SRS triggered by different TRPs in the following examples:
Multiple TRPs triggers the same SRS resource set to be transmitted in the same slot.
Multiple TRPs triggers different SRS resource set to be transmitted in the same slot.
The SRS resource sets triggered by different TRPs are postponed to the same slot.

In this case, there should be some dropping rule to handle the overlapping. In one example, if collision happens, one of the following options could be applied to determine which SRS should be sent:
The SRS triggered by the TRP with the lowest or the highest TRP ID (CORESETPoolIndex) should be transmitted and others will be dropped.
The SRS with the lowest or the highest SRS Resource Set ID should be transmitted and others should be dropped.
The SRS with certain usage should be transmitted. There should be some priority for SRS usage, for example, codebook/non-codebook based transmission should be prioritized.
The most recent triggered SRS should be sent and others should be dropped.
Assuming the available uplink slot for SRS transmission is slot M, a window could be defined, for example, X slots. During the period from slot M-X to slot M, if the first triggered SRS is from TRP #A, then slot M should be used to transmit the SRS triggered by TRP #A. Furthermore, if multiple SRS are triggered by TRP #A during slot M-X to slot M, then the most recent SRS triggered by TRP #A during slot M-X to slot M should be transmitted in slot M. Other SRS triggered during slot M-X to slot M should be dropped.

In another example, if collision happens, then the SRS triggered by the TRP whose CORESETPoolIndex equals to (slotNumber mod 2) should be transmitted.

FIG. 8 shows an example of the collision handling for SRS triggered by multiple TRPs. The SRS triggered by the TRP with the lowest TRP ID is transmitted.

### Scenario B: SRS Transmission in Carrier Aggregation

### SRS Triggering and Configuration

In an embodiment, for carrier aggregation, multiple SRS resource sets could be configured for the same usage (codebook based transmission, non-codebook based transmission, antenna switching and beam management). The multiple SRS resource sets with the same usage could be configured with the same/different trigger state, and the same/different slotOffset.

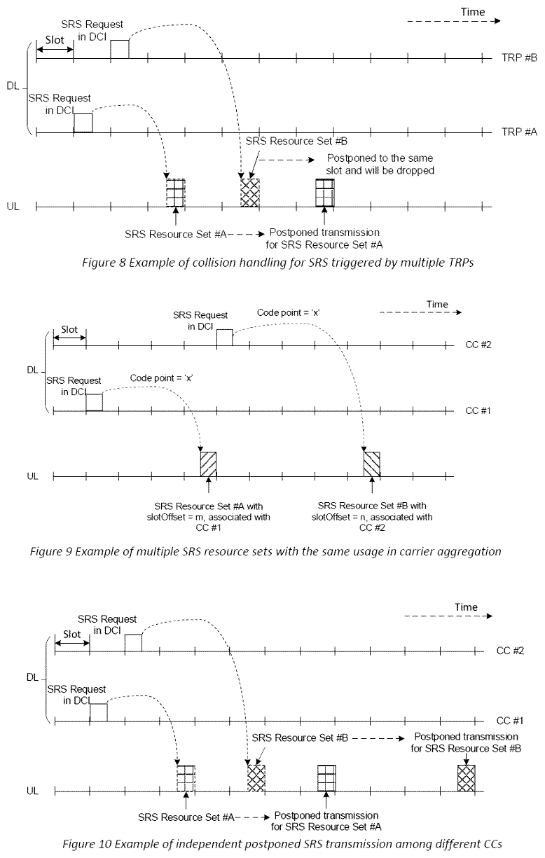

The SRS could be associated with different CC (component carrier). The association between SRS and CC could be defined at SRS resource set level/SRS resource level or in the SRS spatial relation info, by a new RRC parameter, for example, associatedCC-SRS. The SRS resource sets with the same usage setting should be associated with different CC (component carrier). When sending SRS Request in the DCI from one CC, only the SRS resource set associated with the CC will be triggered. FIG. 9 shows an example of the operation.

For codebook based transmission, when scheduling PUSCH transmission, the SRI field indicates one SRS resource in the SRS resource set associated with the scheduling CC. Alternatively, a new field could be introduced in DCI to indicate the SRS resource set.

For non-codebook based transmission, with multiple SRS resource sets, different CSI-RS resource sending by different CC could be associated with different SRS resource set. The UE can calculate different precoders for SRS transmission based on the measurement on CSI-RS. When scheduling PUSCH transmission, the SRI field indicates one or more SRS resources in the SRS resource set associated with the scheduling CC. Alternatively, a new field could be introduced in DCI to indicate the SRS resource set.

### Postponed SRS Transmission and Overlapping Handling

In an embodiment, in carrier aggregation, the postponed SRS transmission could be applied, e.g. if there is no available uplink resource/slot for the SRS transmission, then the triggered SRS should be postponed until the next available uplink slot. The postponed SRS transmission should be performed independently among different carriers. FIG. 10 shows an example of the operation. In the example, CC #1 triggers SRS resource set #A with slot offset of 2 in slot #N, and the SRS resource set #A transmission is postponed to slot #N+6. Between Slot #N and slot #N+6, CC #2 trigger another SRS resource set, SRS resource set #B. In this case, SRS resource set #B will not be transmitted in slot #N+6 and it will be further postponed to slot #N+10. In another example, assuming the available uplink slot for SRS transmission is slot M, a window could be defined for the postponed transmission, for example, X slots. During the period from slot M-X to slot M, if the first triggered SRS is from CC #A, then slot M should be used to transmit the SRS triggered by CC #A. The SRS triggered by another CC, CC #B, during the period from slot M-X to slot M will be further postponed after slot M. Furthermore, if multiple SRS are triggered by C #A during slot M-X to slot M, then the most recent SRS triggered by C #A during slot M-X to slot M should be transmitted in slot M.

In another embodiment, in carrier aggregation, collision will happen for the SRS triggered by different CCs in the following examples:
Multiple CCs triggers the same SRS resource set to be transmitted in the same slot.
Multiple CCs triggers different SRS resource set to be transmitted in the same slot.
The SRS resource sets triggered by different CCs are postponed to the same slot.

In this case, there should be some dropping rule to handle the overlapping. In one example, if collision happens, one of the following options could be applied to determine which SRS should be sent:
The SRS triggered by the CC with the lowest or the highest CC ID should be transmitted and others will be dropped.
The SRS with the lowest or the highest SRS Resource Set ID should be transmitted and others should be dropped.
The SRS with certain usage should be transmitted. There should be some priority for SRS usage, for example, codebook/non-codebook based transmission should be prioritized.
The most recent triggered SRS should be sent and others should be dropped.
Assuming the available uplink slot for SRS transmission is slot M, a window could be defined, for example, X slots. During the period from slot M-X to slot M, if the first triggered SRS is from CC #A, then slot M should be used to transmit the SRS triggered by CC #A. Furthermore, if multiple SRS are triggered by CC #A during slot M-X to slot M, then the most recent SRS triggered by CC #A during slot M-X to slot M should be transmitted in slot M. Other SRS triggered during slot M-X to slot M should be dropped.

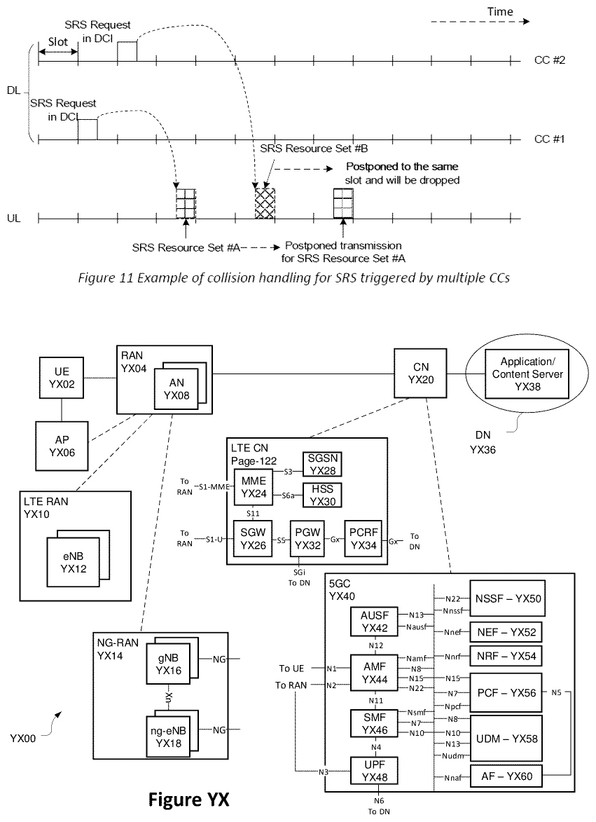

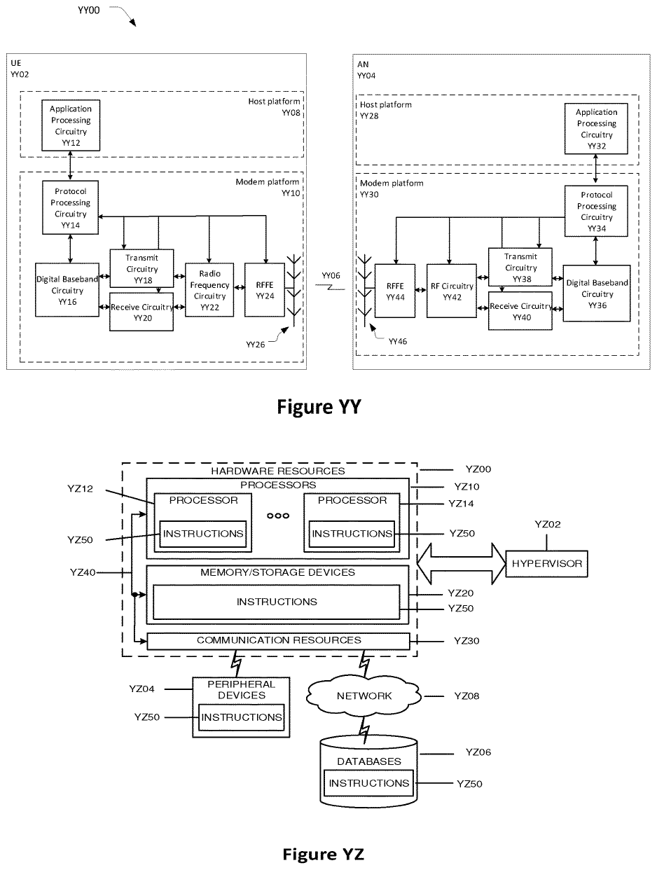

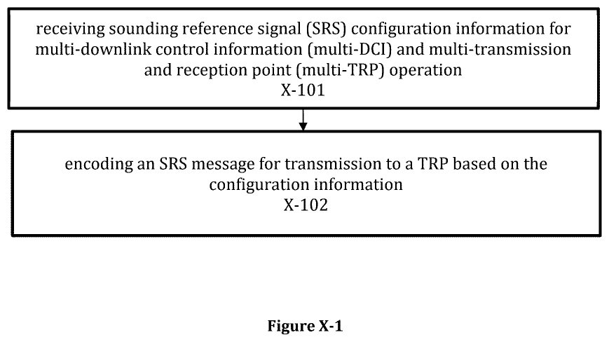

In another example, if collision happens, then the SRS triggered by the CC whose ID equals to (slotNumber mod 2) should be transmitted. FIG. 11 shows an example of the collision handling for SRS triggered by multiple CCs. The SRS triggered by the CC with the lowest CC ID is transmitted.

### SYSTEMS AND IMPLEMENTATIONS

Figures YX-YY illustrate various systems, devices, and components that may implement aspects of disclosed embodiments.

Figure YX illustrates a network YX00 in accordance with various embodiments. The network YX00 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network YX00 may include a UE YX02, which may include any mobile or non-mobile computing device designed to communicate with a RAN YX04 via an over-the-air connection. The UE YX02 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network YX00 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE YX02 may additionally communicate with an AP YX06 via an over-the-air connection. The AP YX06 may manage a WLAN connection, which may serve to offload some/all network traffic from the RAN YX04. The connection between the UE YX02 and the AP YX06 may be consistent with any IEEE 802.11 protocol, wherein the AP YX06 could be a wireless fidelity (Wi-Fi®) router. In some embodiments, the UE YX02, RAN YX04, and AP YX06 may utilize cellular-WLAN aggregation (for example, LWA/LWIP). Cellular-WLAN aggregation may involve the UE YX02 being configured by the RAN YX04 to utilize both cellular radio resources and WLAN resources.

The RAN YX04 may include one or more access nodes, for example, AN YX08. AN YX08 may terminate air-interface protocols for the UE YX02 by providing access stratum protocols including RRC, PDCP, RLC, MAC, and L1 protocols. In this manner, the AN YX08 may enable data/voice connectivity between CN YX20 and the UE YX02. In some embodiments, the AN YX08 may be implemented in a discrete device or as one or more software entities running on server computers as part of, for example, a virtual network, which may be referred to as a CRAN or virtual baseband unit pool. The AN YX08 be referred to as a BS, gNB, RAN node, eNB, ng-eNB, NodeB, RSU, TRxP, TRP, etc. The AN YX08 may be a macrocell base station or a low power base station for providing femtocells, picocells or other like cells having smaller coverage areas, smaller user capacity, or higher bandwidth compared to macrocells.

In embodiments in which the RAN YX04 includes a plurality of ANs, they may be coupled with one another via an X2 interface (if the RAN YX04 is an LTE RAN) or an Xn interface (if the RAN YX04 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN YX04 may each manage one or more cells, cell groups, component carriers, etc. to provide the UE YX02 with an air interface for network access. The UE YX02 may be simultaneously connected with a plurality of cells provided by the same or different ANs of the RAN YX04. For example, the UE YX02 and RAN YX04 may use carrier aggregation to allow the UE YX02 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN YX04 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE YX02 or AN YX08 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN YX04 may be an LTE RAN YX10 with eNBs, for example, eNB YX12. The LTE RAN YX10 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN YX04 may be an NG-RAN YX14 with gNBs, for example, gNB YX16, or ng-eNBs, for example, ng-eNB YX18. The gNB YX16 may connect with 5G-enabled UEs using a 5G NR interface. The gNB YX16 may connect with a 5G core through an NG interface, which may include an N2 interface or an N3 interface. The ng-eNB YX18 may also connect with the 5G core through an NG interface, but may connect with a UE via an LTE air interface. The gNB YX16 and the ng-eNB YX18 may connect with each other over an Xn interface.

In some embodiments, the NG interface may be split into two parts, an NG user plane (NG-U) interface, which carries traffic data between the nodes of the NG-RAN YX14 and a UPF YX48 (e.g., N3 interface), and an NG control plane (NG-C) interface, which is a signaling interface between the nodes of the NG-RANYX14 and an AMF YX44 (e.g., N2 interface).

The NG-RAN YX14 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FRI bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE YX02 can be configured with multiple BWPs where each BWP configuration has a different SCS. When a BWP change is indicated to the UE YX02, the SCS of the transmission is changed as well. Another use case example of BWP is related to power saving. In particular, multiple BWPs can be configured for the UE YX02 with different amount of frequency resources (for example, PRBs) to support data transmission under different traffic loading scenarios. A BWP containing a smaller number of PRBs can be used for data transmission with small traffic load while allowing power saving at the UE YX02 and in some cases at the gNB YX16. A BWP containing a larger number of PRBs can be used for scenarios with higher traffic load.

The RAN YX04 is communicatively coupled to CN YX20 that includes network elements to provide various functions to support data and telecommunications services to customers/subscribers (for example, users of UE YX02). The components of the CN YX20 may be implemented in one physical node or separate physical nodes. In some embodiments, NFV may be utilized to virtualize any or all of the functions provided by the network elements of the CN YX20 onto physical compute/storage resources in servers, switches, etc. A logical instantiation of the CN YX20 may be referred to as a network slice, and a logical instantiation of a portion of the CN YX20 may be referred to as a network sub-slice.

In some embodiments, the CN YX20 may be an LTE CN YX22, which may also be referred to as an EPC. The LTE CN YX22 may include MME YX24, SGW YX26, SGSN YX28, HSS YX30, PGW YX32, and PCRF YX34 coupled with one another over interfaces (or “reference points”) as shown. Functions of the elements of the LTE CN YX22 may be briefly introduced as follows.

The MME YX24 may implement mobility management functions to track a current location of the UE YX02 to facilitate paging, bearer activation/deactivation, handovers, gateway selection, authentication, etc.

The SGW YX26 may terminate an S1 interface toward the RAN and route data packets between the RAN and the LTE CN YX22. The SGW YX26 may be a local mobility anchor point for inter-RAN node handovers and also may provide an anchor for inter-3GPP mobility. Other responsibilities may include lawful intercept, charging, and some policy enforcement.

The SGSN YX28 may track a location of the UE YX02 and perform security functions and access control. In addition, the SGSN YX28 may perform inter-EPC node signaling for mobility between different RAT networks; PDN and S-GW selection as specified by MME YX24; MME selection for handovers; etc. The S3 reference point between the MME YX24 and the SGSN YX28 may enable user and bearer information exchange for inter-3GPP access network mobility in idle/active states.

The HSS YX30 may include a database for network users, including subscription-related information to support the network entities' handling of communication sessions. The HSS YX30 can provide support for routing/roaming, authentication, authorization, naming/addressing resolution, location dependencies, etc. An S6a reference point between the HSS YX30 and the MME YX24 may enable transfer of subscription and authentication data for authenticating/authorizing user access to the LTE CN YX20.

The PGW YX32 may terminate an SGi interface toward a data network (DN) YX36 that may include an application/content server YX38. The PGW YX32 may route data packets between the LTE CN YX22 and the data network YX36. The PGW YX32 may be coupled with the SGW YX26 by an S5 reference point to facilitate user plane tunneling and tunnel management. The PGW YX32 may further include a node for policy enforcement and charging data collection (for example, PCEF). Additionally, the SGi reference point between the PGW YX32 and the data network YX 36 may be an operator external public, a private PDN, or an intra-operator packet data network, for example, for provision of IMS services. The PGW YX32 may be coupled with a PCRF YX34 via a Gx reference point.

The PCRF YX34 is the policy and charging control element of the LTE CN YX22. The PCRF YX34 may be communicatively coupled to the app/content server YX38 to determine appropriate QoS and charging parameters for service flows. The PCRF YX32 may provision associated rules into a PCEF (via Gx reference point) with appropriate TFT and QCI.

In some embodiments, the CN YX20 may be a 5GC YX40. The 5GC YX40 may include an AUSF YX42, AMF YX44, SMF YX46, UPF YX48, NSSF YX50, NEF YX52, NRF YX54, PCF YX56, UDM YX58, and AF YX60 coupled with one another over interfaces (or “reference points”) as shown. Functions of the elements of the 5GC YX40 may be briefly introduced as follows.

The AUSF YX42 may store data for authentication of UE YX02 and handle authentication-related functionality. The AUSF YX42 may facilitate a common authentication framework for various access types. In addition to communicating with other elements of the 5GC YX40 over reference points as shown, the AUSF YX42 may exhibit an Nausf service-based interface.

The AMF YX44 may allow other functions of the 5GC YX40 to communicate with the UE YX02 and the RAN YX04 and to subscribe to notifications about mobility events with respect to the UE YX02. The AMF YX44 may be responsible for registration management (for example, for registering UE YX02), connection management, reachability management, mobility management, lawful interception of AMF-related events, and access authentication and authorization. The AMF YX44 may provide transport for SM messages between the UE YX02 and the SMF YX46, and act as a transparent proxy for routing SM messages. AMF YX44 may also provide transport for SMS messages between UE YX02 and an SMSF. AMF YX44 may interact with the AUSF YX42 and the UE YX02 to perform various security anchor and context management functions. Furthermore, AMF YX44 may be a termination point of a RAN CP interface, which may include or be an N2 reference point between the RAN YX04 and the AMF YX44; and the AMF YX44 may be a termination point of NAS (N1) signaling, and perform NAS ciphering and integrity protection. AMF YX44 may also support NAS signaling with the UE YX02 over an N3 IWF interface.

The SMF YX46 may be responsible for SM (for example, session establishment, tunnel management between UPF YX48 and AN YX08); UE IP address allocation and management (including optional authorization); selection and control of UP function; configuring traffic steering at UPF YX48 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF YX44 over N2 to AN YX08; and determining SSC mode of a session. SM may refer to management of a PDU session, and a PDU session or “session” may refer to a PDU connectivity service that provides or enables the exchange of PDUs between the UE YX02 and the data network YX36.

The UPF YX48 may act as an anchor point for intra-RAT and inter-RAT mobility, an external PDU session point of interconnect to data network YX36, and a branching point to support multi-homed PDU session. The UPF YX48 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF YX48 may include an uplink classifier to support routing traffic flows to a data network.

The NSSF YX50 may select a set of network slice instances serving the UE YX02. The NSSF YX50 may also determine allowed NSSAI and the mapping to the subscribed S-NSSAIs, if needed. The NSSF YX50 may also determine the AMF set to be used to serve the UE YX02, or a list of candidate AMFs based on a suitable configuration and possibly by querying the NRF YX54. The selection of a set of network slice instances for the UE YX02 may be triggered by the AMF YX44 with which the UE YX02 is registered by interacting with the NSSF YX50, which may lead to a change of AMF. The NSSF YX50 may interact with the AMF YX44 via an N22 reference point; and may communicate with another NSSF in a visited network via an N31 reference point (not shown). Additionally, the NSSF YX50 may exhibit an Nnssf service-based interface.

The NEF YX52 may securely expose services and capabilities provided by 3GPP network functions for third party, internal exposure/re-exposure, AFs (e.g., AF YX60), edge computing or fog computing systems, etc. In such embodiments, the NEF YX52 may authenticate, authorize, or throttle the AFs. NEF YX52 may also translate information exchanged with the AF YX60 and information exchanged with internal network functions. For example, the NEF YX52 may translate between an AF-Service-Identifier and an internal 5GC information. NEF YX52 may also receive information from other NFs based on exposed capabilities of other NFs. This information may be stored at the NEF YX52 as structured data, or at a data storage NF using standardized interfaces. The stored information can then be re-exposed by the NEF YX52 to other NFs and AFs, or used for other purposes such as analytics. Additionally, the NEF YX52 may exhibit an Nnef service-based interface.

The NRF YX54 may support service discovery functions, receive NF discovery requests from NF instances, and provide the information of the discovered NF instances to the NF instances. NRF YX54 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF YX54 may exhibit the Nnrf service-based interface.

The PCF YX56 may provide policy rules to control plane functions to enforce them, and may also support unified policy framework to govern network behavior. The PCF YX56 may also implement a front end to access subscription information relevant for policy decisions in a UDR of the UDM YX58. In addition to communicating with functions over reference points as shown, the PCF YX56 exhibit an Npcf service-based interface.

The UDM YX58 may handle subscription-related information to support the network entities' handling of communication sessions, and may store subscription data of UE YX02. For example, subscription data may be communicated via an N8 reference point between the UDM YX58 and the AMF YX44. The UDM YX58 may include two parts, an application front end and a UDR. The UDR may store subscription data and policy data for the UDM YX58 and the PCF YX56, and/or structured data for exposure and application data (including PFDs for application detection, application request information for multiple UEs YX02) for the NEF YX52. The Nudr service-based interface may be exhibited by the UDR 221 to allow the UDM YX58, PCF YX56, and NEF YX52 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM YX58 may exhibit the Nudm service-based interface.

The AF YX60 may provide application influence on traffic routing, provide access to NEF, and interact with the policy framework for policy control.

In some embodiments, the 5GC YX40 may enable edge computing by selecting operator/3rd party services to be geographically close to a point that the UE YX02 is attached to the network. This may reduce latency and load on the network. To provide edge-computing implementations, the 5GC YX40 may select a UPF YX48 close to the UE YX02 and execute traffic steering from the UPF YX48 to data network YX36 via the N6 interface. This may be based on the UE subscription data, UE location, and information provided by the AF YX60. In this way, the AF YX60 may influence UPF (re) selection and traffic routing. Based on operator deployment, when AF YX60 is considered to be a trusted entity, the network operator may permit AF YX60 to interact directly with relevant NFs. Additionally, the AF YX60 may exhibit an Naf service-based interface.

The data network YX36 may represent various network operator services, Internet access, or third party services that may be provided by one or more servers including, for example, application/content server YX38.

Figure YY schematically illustrates a wireless network YY00 in accordance with various embodiments. The wireless network YY00 may include a UE YY02 in wireless communication with an AN YY04. The UE YY02 and AN YY04 may be similar to, and substantially interchangeable with, like-named components described elsewhere herein.

The UE YY02 may be communicatively coupled with the AN YY04 via connection YY06. The connection YY06 is illustrated as an air interface to enable communicative coupling, and can be consistent with cellular communications protocols such as an LTE protocol or a 5G NR protocol operating at mmWave or sub-6 GHz frequencies.

The UE YY02 may include a host platform YY08 coupled with a modem platform YY10. The host platform YY08 may include application processing circuitry YY12, which may be coupled with protocol processing circuitry YY14 of the modem platform YY10. The application processing circuitry YY12 may run various applications for the UE YY02 that source/sink application data. The application processing circuitry YY12 may further implement one or more layer operations to transmit/receive application data to/from a data network. These layer operations may include transport (for example UDP) and Internet (for example, IP) operations

The protocol processing circuitry YY14 may implement one or more of layer operations to facilitate transmission or reception of data over the connection YY06. The layer operations implemented by the protocol processing circuitry YY14 may include, for example, MAC, RLC, PDCP, RRC and NAS operations.

The modem platform YY10 may further include digital baseband circuitry YY16 that may implement one or more layer operations that are “below” layer operations performed by the protocol processing circuitry YY14 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform YY10 may further include transmit circuitry YY18, receive circuitry YY20, RF circuitry YY22, and RF front end (RFFE) YY24, which may include or connect to one or more antenna panels YY26. Briefly, the transmit circuitry YY18 may include a digital-to-analog converter, mixer, intermediate frequency (IF) components, etc.; the receive circuitry YY20 may include an analog-to-digital converter, mixer, IF components, etc.; the RF circuitry YY22 may include a low-noise amplifier, a power amplifier, power tracking components, etc.; RFFE YY24 may include filters (for example, surface/bulk acoustic wave filters), switches, antenna tuners, beamforming components (for example, phase-array antenna components), etc. The selection and arrangement of the components of the transmit circuitry YY18, receive circuitry YY20, RF circuitry YY22, RFFE YY24, and antenna panels YY26 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry YY14 may include one or more instances of control circuitry (not shown) to provide control functions for the transmit/receive components.

A UE reception may be established by and via the antenna panels YY26, RFFE YY24, RF circuitry YY22, receive circuitry YY20, digital baseband circuitry YY16, and protocol processing circuitry YY14. In some embodiments, the antenna panels YY26 may receive a transmission from the AN YY04 by receive-beamforming signals received by a plurality of antennas/antenna elements of the one or more antenna panels YY26.

A UE transmission may be established by and via the protocol processing circuitry YY14, digital baseband circuitry YY16, transmit circuitry YY18, RF circuitry YY22, RFFE YY24, and antenna panels YY26. In some embodiments, the transmit components of the UE YY04 may apply a spatial filter to the data to be transmitted to form a transmit beam emitted by the antenna elements of the antenna panels YY26.

Similar to the UE YY02, the AN YY04 may include a host platform YY28 coupled with a modem platform YY30. The host platform YY28 may include application processing circuitry YY32 coupled with protocol processing circuitry YY34 of the modem platform YY30. The modem platform may further include digital baseband circuitry YY36, transmit circuitry YY38, receive circuitry YY40, RF circuitry YY42, RFFE circuitry YY44, and antenna panels YY46. The components of the AN YY04 may be similar to and substantially interchangeable with like-named components of the UE YY02. In addition to performing data transmission/reception as described above, the components of the AN YY08 may perform various logical functions that include, for example, RNC functions such as radio bearer management, uplink and downlink dynamic radio resource management, and data packet scheduling.

Figure YZ is a block diagram illustrating components, according to some example embodiments, able to read instructions from a machine-readable or computer-readable medium (e.g., a non-transitory machine-readable storage medium) and perform any one or more of the methodologies discussed herein. Specifically, Figure YZ shows a diagrammatic representation of hardware resources YZ00 including one or more processors (or processor cores) YZ10, one or more memory/storage devices YZ20, and one or more communication resources YZ30, each of which may be communicatively coupled via a bus YZ40 or other interface circuitry. For embodiments where node virtualization (e.g., NFV) is utilized, a hypervisor YZ02 may be executed to provide an execution environment for one or more network slices/sub-slices to utilize the hardware resources YZ00.

The processors YZ10 may include, for example, a processor YZ12 and a processor YZ14. The processors YZ10 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices YZ20 may include main memory, disk storage, or any suitable combination thereof. The memory/storage devices YZ20 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources YZ30 may include interconnection or network interface controllers, components, or other suitable devices to communicate with one or more peripheral devices YZ04 or one or more databases YZ06 or other network elements via a network YZ08. For example, the communication resources YZ30 may include wired communication components (e.g., for coupling via USB, Ethernet, etc.), cellular communication components, NFC components, Bluetooth® (or Bluetooth® Low Energy) components, Wi-Fi® components, and other communication components.

Instructions YZ50 may comprise software, a program, an application, an applet, an app, or other executable code for causing at least any of the processors YZ10 to perform any one or more of the methodologies discussed herein. The instructions YZ50 may reside, completely or partially, within at least one of the processors YZ10 (e.g., within the processor's cache memory), the memory/storage devices YZ20, or any suitable combination thereof. Furthermore, any portion of the instructions YZ50 may be transferred to the hardware resources YZ00 from any combination of the peripheral devices YZ04 or the databases YZ06. Accordingly, the memory of processors YZ10, the memory/storage devices YZ20, the peripheral devices YZ04, and the databases YZ06 are examples of computer-readable and machine-readable media.

### Example Procedures

In some embodiments, the electronic device(s), network(s), system(s), chip(s) or component(s), or portions or implementations thereof, of Figures YX-YZ, or some other figure herein, may be configured to perform one or more processes, techniques, or methods as described herein, or portions thereof. One such process is depicted in Figure X-1, which may be performed by a user equipment (UE) or portion thereof. For example, the process may include, at X-101, receiving sounding reference signal (SRS) configuration information for multi-downlink control information (multi-DCI) and multi-transmission and reception point (multi-TRP) operation. The process further includes, at X-102, encoding an SRS message for transmission to a TRP based on the configuration information.

In some embodiments, the SRS configuration information is included in DCI and includes a TRP-specific SRS trigger state indicated by a code point of an SRS request field. For example, the code point of the SRS request field may be to trigger different SRS resource sets by different TRPs. In some embodiments, the code point of the SRS request field is to trigger a common SRS resource set with different slot offsets.

In some embodiments, the SRS configuration information includes an indication of multiple SRS resource sets configured for a common usage. For example, the common usage may include: codebook based transmission, non-codebook based transmission, antenna switching, or beam management.

In some embodiments, the configuration information is to identify an association between the SRS transmission and a plurality of TRPs. In some embodiments, the configuration information is to indicate an SRS resource in an SRS resource set associated with a scheduling TRP.

In some embodiments, encoding the SRS transmission for transmission includes: determining there is no available uplink slot available for the SRS transmission; and postponing the SRS transmission until a next available uplink slot.

In some embodiments, the UE may identify an SRS collision among multiple TRPs and encode one of a plurality of SRS messages for transmission based on a priority associated with the one SRS message. For example, the priority may be based on: an identifier of a TRP associated with the one SRS message, an SRS resource identifier associated with the one SRS message, a usage type associated with the one SRS message, a timestamp associated with the one SRS message, or an ordering of the one SRS message relative to the plurality of SRS messages.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method of operating a wireless network wherein a transmission and reception point (TRP) is adapted for multi-DCI Multi-TRP operation, and can configure a user equipment (UE) for a sounding reference signal (SRS) transmission.

Example 2 may include the method of example 1 or some other example herein, wherein a next-generation NodeB (gNB) is adapted to work with multiple component carriers, and can configure the UE for the SRS transmission.

Example 3 may include the method of examples 1 or 2 or some other example herein, wherein the UE transmit SRS to the TRP according to the configuration.

Example 4 may include the method of example 1 and example 3 or some other example herein, wherein for SRS triggering in multi-DCI multi-TRP, the SRS trigger state indicated by the code point of SRS Request field in DCI could be TRP specific. The same code point of SRS Request field could trigger different SRS resource set by different TRPs.

Example 5 may include the method of example 1 and example 3 or some other example herein, wherein for SRS triggering in multi-DCI multi-TRP, the same code point of SRS Request field in DCI from different TRPs could trigger the same SRS resource set but with different slot offset.

Example 6 may include the method of example 1 and example 3 or some other example herein, wherein the SRS could be associated with different TRPs, e.g. different CORESETPoolIndex. The association between SRS and TRP could be defined at SRS resource set level/SRS resource level or in the SRS spatial relation info, by a new RRC parameter, for example, associatedCORESETPool-SRS.

Example 7 may include the method of example 1 and example 3 or some other example herein, wherein for multi-DCI multi-TRP, multiple SRS resource sets could be configured for the same usage (codebook based transmission, non-codebook based transmission, antenna switching and beam management). The multiple SRS resource sets with the same usage could be configured with the same/different trigger state, and the same/different slotOffset.

Example 8 may include the method of example 6 and example 7 or some other example herein, wherein The SRS resource sets with the same usage setting should be associated with different TRPs. For example, in the multi-TRP operation with two TRPs, two SRS resource sets could be defined for codebook based transmission, and each SRS resource set is associate with one TRP. When sending SRS Request in the DCI from one TRP, only the SRS resource set associated with the TRP will be triggered.

Example 9 may include the method of example 6 and example 7 or some other example herein, wherein For codebook based transmission, when scheduling PUSCH transmission, the SRI field indicates one SRS resource in the SRS resource set associated with the scheduling TRP. Alternatively, a new field could be introduced in DCI to indicate the SRS resource set. For non-codebook based transmission, with multiple SRS resource sets, different CSI-RS resource sending by different TRP could be associated with different SRS resource set. The UE can calculate different precoders for SRS transmission toward different TRPs based on the measurement on CSI-RS. When scheduling PUSCH transmission, the SRI field indicates one or more SRS resources in the SRS resource set associated with the scheduling TRP. Alternatively, a new field could be introduced in DCI to indicate the SRS resource set.

Example 10 may include the method of example 1 and example 3 or some other example herein, wherein in multi-DCI multi-TRP, the postponed SRS transmission could be applied, e.g. if there is no available uplink resource/slot for the SRS transmission, then the triggered SRS should be postponed until the next available uplink slot. The postponed SRS transmission should be performed independently among TRPs. There should be some coordination among TRPs. Assuming the available uplink slot for SRS transmission is slot M, a window could be defined for the postponed transmission, for example, X slots. During the period from slot M-X to slot M, if the first triggered SRS is from TRP #A, then slot M should be used to transmit the SRS triggered by TRP #A. The SRS triggered by another TRP, TRP #B, during the period from slot M-X to slot M will be further postponed after slot M. Furthermore, if multiple SRS are triggered by TRP #A during slot M-X to slot M, then the most recent SRS triggered by TRP #A during slot M-X to slot M should be transmitted in slot M.

Example 11 may include the method of example 1 and example 3 or some other example herein, wherein in multi-DCI multi-TRP, if collision happens for SRS transmission, one of the following options could be applied to determine which SRS should be sent:
The SRS triggered by the TRP with the lowest or the highest TRP ID (CORESETPoolIndex) should be transmitted and others will be dropped.
The SRS with the lowest or the highest SRS Resource Set ID should be transmitted and others should be dropped.
The SRS with certain usage should be transmitted. There should be some priority for SRS usage, for example, codebook/non-codebook based transmission should be prioritized.
The most recent triggered SRS should be sent and others should be dropped.
Assuming the available uplink slot for SRS transmission is slot M, a window could be defined, for example, X slots. During the period from slot M-X to slot M, if the first triggered SRS is from TRP #A, then slot M should be used to transmit the SRS triggered by TRP #A. Furthermore, if multiple SRS are triggered by TRP #A during slot M-X to slot M, then the most recent SRS triggered by TRP #A during slot M-X to slot M should be transmitted in slot M. Other SRS triggered during slot M-X to slot M should be dropped.
The SRS triggered by the TRP whose CORESETPoolIndex equals to (slotNumber mod 2) should be transmitted.

Example 12 may include the method of example 2 and example 3 or some other example herein, wherein for carrier aggregation, The SRS could be associated with different CC (component carrier). The association between SRS and CC could be defined at SRS resource set level/SRS resource level or in the SRS spatial relation info, by a new RRC parameter, for example, associatedCC-SRS.

Example 13 may include the method of example 2 and example 3 or some other example herein, wherein multiple SRS resource sets could be configured for the same usage (codebook based transmission, non-codebook based transmission, antenna switching and beam management). The multiple SRS resource sets with the same usage could be configured with the same/different trigger state, and the same/different slotOffset.

Example 14 may include the method of example 12 and example 13 or some other example herein, wherein The SRS resource sets with the same usage setting should be associated with different CC (component carrier). When sending SRS Request in the DCI from one CC, only the SRS resource set associated with the CC will be triggered.

Example 15 may include the method of example 12 and example 13 or some other example herein, wherein for codebook based transmission, when scheduling PUSCH transmission, the SRI field indicates one SRS resource in the SRS resource set associated with the scheduling CC. Alternatively, a new field could be introduced in DCI to indicate the SRS resource set. For non-codebook based transmission, with multiple SRS resource sets, different CSI-RS resource sending by different CC could be associated with different SRS resource set. The UE can calculate different precoders for SRS transmission based on the measurement on CSI-RS. When scheduling PUSCH transmission, the SRI field indicates one or more SRS resources in the SRS resource set associated with the scheduling CC. Alternatively, a new field could be introduced in DCI to indicate the SRS resource set.

Example 16 may include the method of example 2 and example 3 or some other example herein, wherein in carrier aggregation, the postponed SRS transmission could be applied, e.g. if there is no available uplink resource/slot for the SRS transmission, then the triggered SRS should be postponed until the next available uplink slot. The postponed SRS transmission should be performed independently among different carriers. Assuming the available uplink slot for SRS transmission is slot M, a window could be defined for the postponed transmission, for example, X slots. During the period from slot M-X to slot M, if the first triggered SRS is from CC #A, then slot M should be used to transmit the SRS triggered by CC #A. The SRS triggered by another CC, CC #B, during the period from slot M-X to slot M will be further postponed after slot M. Furthermore, if multiple SRS are triggered by C#A during slot M-X to slot M, then the most recent SRS triggered by C#A during slot M-X to slot M should be transmitted in slot M.

Example 17 may include the method of example 2 and example 3 or some other example herein, wherein in carrier aggregation, if collision happens for SRS transmission, one of the following options could be applied to determine which SRS should be sent:
The SRS triggered by the CC with the lowest or the highest CC ID should be transmitted and others will be dropped.
The SRS with the lowest or the highest SRS Resource Set ID should be transmitted and others should be dropped.
The SRS with certain usage should be transmitted. There should be some priority for SRS usage, for example, codebook/non-codebook based transmission should be prioritized.
The most recent triggered SRS should be sent and others should be dropped.
Assuming the available uplink slot for SRS transmission is slot M, a window could be defined, for example, X slots. During the period from slot M-X to slot M, if the first triggered SRS is from CC #A, then slot M should be used to transmit the SRS triggered by CC #A. Furthermore, if multiple SRS are triggered by CC #A during slot M-X to slot M, then the most recent SRS triggered by CC #A during slot M-X to slot M should be transmitted in slot M. Other SRS triggered during slot M-X to slot M should be dropped.
The SRS triggered by the CC whose ID equals to (slotNumber mod 2) should be transmitted.

Example 18 includes a method comprising:
receiving sounding reference signal (SRS) configuration information for multi-downlink control information (multi-DCI) and multi-transmission and reception point (multi-TRP) operation; and
encoding an SRS message for transmission to a TRP based on the configuration information.

Example 19 includes the method of example 18 or some other example herein, wherein the configuration information included in DCI and includes a TRP-specific SRS trigger state indicated by a code point of an SRS request field.

Example 20 includes the method of example 19 or some other example herein, wherein the code point of the SRS request field is to trigger different SRS resource sets by different TRPs.

Example 21 includes the method of example 19 or some other example herein, wherein the code point of the SRS request field is to trigger a common SRS resource set with different slot offsets.

Example 22 includes the method of example 18 or some other example herein, wherein the SRS configuration information includes an indication of multiple SRS resource sets configured for a common usage.

Example 23 includes the method of example 22 or some other example herein, wherein the common usage includes: codebook based transmission, non-codebook based transmission, antenna switching, or beam management.

Example 24 includes the method of example 18 or some other example herein, wherein the configuration information is to identify an association between the SRS transmission and a plurality of TRPs.

Example 25 includes the method of example 18 or some other example herein, wherein the configuration information is to indicate an SRS resource in an SRS resource set associated with a scheduling TRP.

Example 26 includes the method of example 18 or some other example herein, wherein encoding the SRS transmission for transmission includes:
determining there is no available uplink slot available for the SRS transmission; and
postponing the SRS transmission until a next available uplink slot.

Example 27 includes the method of example 18 or some other example herein, wherein the method further includes:
identifying an SRS collision among multiple TRPs; and
encoding one of a plurality of SRS messages for transmission based on a priority associated with the one SRS message.

Example 28 includes the method of example 27 or some other example herein, wherein the priority is based on: an identifier of a TRP associated with the one SRS message, an SRS resource identifier associated with the one SRS message, a usage type associated with the one SRS message, a timestamp associated with the one SRS message, or an ordering of the one SRS message relative to the plurality of SRS messages.

Example 29 includes the method of any of examples 18-28 or some other example herein, wherein the method is performed by a user equipment (UE) or portion thereof.

Example Z01 may include an apparatus comprising means to perform one or more elements of a method described in or related to any of examples 1-29, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-29, or any other method or process described herein.

Example Z03 may include an apparatus comprising logic, modules, or circuitry to perform one or more elements of a method described in or related to any of examples 1-29, or any other method or process described herein.

Example Z04 may include a method, technique, or process as described in or related to any of examples 1-29, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-29, or portions thereof.

Example Z06 may include a signal as described in or related to any of examples 1-29, or portions or parts thereof.

Example Z07 may include a datagram, packet, frame, segment, protocol data unit (PDU), or message as described in or related to any of examples 1-29, or portions or parts thereof, or otherwise described in the present disclosure.

Example Z08 may include a signal encoded with data as described in or related to any of examples 1-29, or portions or parts thereof, or otherwise described in the present disclosure.

Example Z09 may include a signal encoded with a datagram, packet, frame, segment, protocol data unit (PDU), or message as described in or related to any of examples 1-29, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-29, or portions thereof.

Example Z11 may include a computer program comprising instructions, wherein execution of the program by a processing element is to cause the processing element to carry out the method, techniques, or process as described in or related to any of examples 1-29, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### ABBREVIATIONS

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| ACK | Acknowledgement |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CFRA | Contention Free Random Access |
| CG | Cell Group |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, CSI-RS |
| | Resource Indicator |
| C-RNTI | Cell RNTI |
| CS | Circuit Switched |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, | Demodulation Reference Signal |
| DMRS | |
| DN | Data network |
| DRB | Data Radio Bearer |
| DRS | Discovery Reference Signal |
| DRX | Discontinuous Reception |
| DSL | Domain Specific Language. Digital Subscriber Line |
| DSLAM | DSL Access Multiplexer |
| DwPTS | Downlink Pilot Time Slot |
| E-LAN | Ethernet Local Area Network |
| E2E | End-to-End |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM Evolution) |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink Control |
| | Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated Circuit |
| | Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, further |
| | enhanced LAA |
| FN | Frame Number |
| FPGA | Field-Programmable Gate Array |
| FR | Frequency Range |
| G-RNTI | GERAN Radio Network Temporary Identity |
| GERAN | GSM EDGE RAN, GSM EDGE Radio Access Network |
| GGSN | Gateway GPRS Support Node |
| GLONASS | GLObal'naya NAvigatsionnaya Sputnikovaya Sistema |
| | (Engl.: Global Navigation Satellite System) |
| gNB | Next Generation NodeB |
| gNB-CU | gNB-centralized unit, Next Generation NodeB centralized |
| | unit |
| gNB-DU | gNB-distributed unit, Next Generation NodeB distributed |
| | unit |
| GNSS | Global Navigation Satellite System |
| GPRS | General Packet Radio Service |
| GSM | Global System for Mobile Communications, Groupe |
| | Special Mobile |
| GTP | GPRS Tunneling Protocol |
| GTP-U | GPRS Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is http/1.1 over |
| | SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IM | Interference Measurement, Intermodulation, IP Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPv4 | Internet Protocol Version 4 |
| IPv6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec Tunnel |
| LTE | Long Term Evolution |
| M2M | Machine-to-Machine |
| MAC | Medium Access Control (protocol layering context) |
| MAC | Message authentication code (security/encryption context) |
| MAC-A | MAC used for authentication and key agreement (TSG T |
| | WG3 context) |
| MAC-I | MAC used for data integrity of signalling messages (TSG T |
| | WG3 context) |
| MANO | Management and Orchestration |
| MBMS | Multimedia Broadcast and Multicast Service |
| MBSFN | Multimedia Broadcast multicast service Single Frequency |
| | Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management Information Base |
| MIMO | Multiple Input Multiple Output |
| MLC | Mobile Location Centre |
| MM | Mobility Management |
| MME | Mobility Management Entity |
| MN | Master Node |
| MnS | Management Service |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTC | massive MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM | Network Manager |
| NMS | Network Management System |
| NPoP | Network Point of Presence |
| NMIB, | Narrowband MIB |
| N-MIB | |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Plysical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSFCH | Physical Sidelink Feedback Channel |
| PSSCH | Physical Sidelink Shared Channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Phase Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System Information |
| RN | Relay Node |
| RNC | Radio Network Controller |
| RNL | Radio Network Laver |
| RNTI | Radio Network Temporary Identifier |
| ROHC | RObust Header Compression |
| RRC | Radio Resource Control, Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data Adaptation |
| | Protocol layer |
| SDL | Supplementary Downlink |
| SDNF | Structured Data Storage Network Function |
| SDP | Session Description Protocol |
| SDSF | Structured Data Storage Function |
| SDU | Service Data Unit |
| SEAF | Security Anchor Function |
| SeNB | secondary eNB |
| SEPP | Security Edge Protection Proxy |
| SFI | Slot formal indication |
| SFTD | Space-Frequency Time Diversity, SFN and frame timing |
| | difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI- | Semi-Persistent CSI RNTI |
| RNTI | |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | SS Block |
| SSBRI | SSB Resource Indicator |
| SSC | Session and Service Continuity |
| SS-RSRP | Synchronization Signal based Reference Signal Received |
| | Power |
| SS-RSRQ | Synchronization Signal based Reference Signal Received |
| | Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Recention Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDR | Unified Data Repository |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VoIP | Voice-over-IP, Voice-over-Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1. (canceled)

2. An apparatus for use in a user equipment (UE), the apparatus comprising processing circuitry and memory, wherein the processing circuitry is configured to:
receive downlink control information (DCI) from a plurality of transmission and reception points (TRPs) in a multi-DCI multi-TRP operation, wherein the DCI includes a sounding reference signal (SRS) request field or SRS resource set indicator field;
determine, based on a codepoint of the SRS request field or the SRS resource set indicator field of the received DCI, an SRS resource set to be triggered;
associate the determined SRS resource set with the TRP or a CORESETPoolIndex; and
transmit one or more SRS resources corresponding to the determined SRS resource set after a slot offset associated with the determined SRS resource set.

3. The apparatus of claim 2, wherein the SRS resource set is configured as an aperiodic SRS resource set by a higher-layer SRS parameter.

4. The apparatus of claim 2, wherein each SRS resource set is configured with a unique SRS resource set identifier (srsResourceSetId).

5. The apparatus of claim 4, wherein the SRS resource set is configured with a usage type of codebook-based transmission, non-codebook-based transmission, antenna switching, or beam management.

6. The apparatus of claim 2, wherein one or more downlink control information (DCI) codepoints are configured to trigger transmission of a corresponding Sounding Reference Signal (SRS) resource set.

7. The apparatus of claim 2, wherein the processing circuitry is further configured to apply a dropping rule when an overlap occurs between the determined SRS resource set and another SRS transmission or a prioritization rule when a collision occurs between the determined SRS resource set and another SRS transmission.

8. The apparatus of claim 2, wherein only an SRS resource set associated with the TRP or CORESETPoolIndex of the received DCI is eligible to be triggered.

9. The apparatus of claim 2, wherein the SRS resource set associated with codebook-based transmission or non-codebook-based transmission is utilized for uplink precoding, the uplink precoding being determined based on a transmission precoding matrix index (TPMI) or a sounding reference signal resource index (SRI).

10. The apparatus of claim 2, wherein the SRS resource set further comprises configuration parameters including an aperiodic SRS resource trigger (aperiodicSRS-ResourceTrigger) and an aperiodic SRS resource trigger list (aperiodicSRS-ResourceTriggerList).

11. A non-transitory computer-readable medium comprising instructions that when executed by processing circuitry of user equipment (UE), cause the processing circuitry to:
receive downlink control information (DCI) from a plurality of transmission and reception points (TRPs) in a multi-DCI multi-TRP operation, wherein the DCI includes a sounding reference signal (SRS) request field or SRS resource set indicator field;
determine, based on a codepoint of the SRS request field or the SRS resource set indicator field of the received DCI, an SRS resource set to be triggered;
associate the determined SRS resource set with the TRP or a CORESETPoolIndex; and
transmit one or more SRS resources corresponding to the determined SRS resource set after a slot offset associated with the determined SRS resource set.

12. The non-transitory computer-readable medium of claim 11, wherein the SRS resource set is configured as an aperiodic SRS resource set by a higher-layer SRS parameter.

13. The non-transitory computer-readable medium of claim 11, wherein each SRS resource set is configured with a unique SRS resource set identifier (srsResourceSetId).

14. The non-transitory computer-readable medium of claim 13, wherein the SRS resource set is configured with a usage type of codebook-based transmission, non-codebook-based transmission, antenna switching, or beam management.

15. The non-transitory computer-readable medium of claim 11, wherein one or more downlink control information (DCI) codepoints are configured to trigger transmission of a corresponding Sounding Reference Signal (SRS) resource set.

16. The non-transitory computer-readable medium of claim 11, wherein the operations further comprise to: apply a dropping rule when an overlap occurs between the determined SRS resource set and another SRS transmission or a prioritization rule when a collision occurs between the determined SRS resource set and another SRS transmission.

17. The non-transitory computer-readable medium of claim 11, wherein only an SRS resource set associated with the TRP or CORESETPoolIndex of the received DCI is eligible to be triggered.

18. The non-transitory computer-readable medium of claim 11, wherein the SRS resource set associated with codebook-based transmission or non-codebook-based transmission is utilized for uplink precoding, the uplink precoding being determined based on a transmission precoding matrix index (TPMI) or a sounding reference signal resource index (SRI).

19. The non-transitory computer-readable medium of claim 11, wherein the SRS resource set further comprises configuration parameters including an aperiodic SRS resource trigger (aperiodicSRS-ResourceTrigger) and an aperiodic SRS resource trigger list (aperiodicSRS-ResourceTriggerList).

20. An apparatus of user equipment (UE), the apparatus comprising:
memory coupled to processor circuitry configured to:
identify downlink control information (DCI) associated with triggering a Sounding Reference Signal (SRS) resource set in a multi-DCI multi-TRP operation, wherein the DCI includes an SRS request field or SRS resource set indicator field;
determine, based on the DCI, the SRS resource set to be triggered; and
transmit the SRS resource set.
